(19) United States
(12) Patent Application Publication
(10) Pub. No.: US 2014/0208745 A1
(43) Pub. Date: Jul. 31, 2014

(54) CONTROL STRATEGY FOR AN ENGINE

(71) Applicant: Eaton Corporation, Cleveland, OH (US)

(72) Inventors: Christopher Suhocki, Marshall, MI (US); Michael J. Silar, Marshall, MI (US); Robert P. Benjey, Dexter, MI (US); William N. Eybergen, Macomb County, MI (US); Vasillos Tsourapas, Northville, MI (US); Martin D. Pryor, Canton, MI (US); Daniel R. Ouwenga, Portage, MI (US)

(21) Appl. No.: 14/171,123

(22) Filed: Feb. 3, 2014

Related U.S. Application Data
(63) Continuation-in-part of application No. 12/607,169, filed on Oct. 28, 2009, now Pat. No. 8,640,458.
Application No. 12/607,169 is a continuation-in-part of application No. PCT/US2013/003094, filed on Mar. 13, 2013.
(60) Provisional application No. 61/617,152, filed on Mar. 29, 2012.
(60) Provisional application No. 61/911,310, filed on Dec. 3, 2013.

(51) Int. Cl. F02B 33/40

(52) U.S. Cl. CPC F02B 33/40
USPC 60/611; 60/273

(57) ABSTRACT

The present disclosure relates to a method of controlling an engine. The method includes manipulating a combustion air bypass valve between an open position and a closed position to create a negative pressure differential across a supercharger. The negative pressure differential is converted into a torque by the supercharger and transmitted from the supercharger back to the engine.

### CROSS REFERENCE TO RELATED APPLICATIONS

This application claims the benefit of U.S. patent application Ser. No. 12/607,169, entitled “CONTROL STRATEGY FOR AN ENGINE,” filed Oct. 28, 2009; PCT Application No. PCT/US2013/003094, entitled “VARIABLE SPEED HYBRID ELECTRIC SUPERCHARGER ASSEMBLY AND METHOD OF CONTROL OF VEHICLE HAVING SAME,” filed Mar. 13, 2013, which claims priority to U.S. Provisional Application Ser. No. 61/617,152, filed Mar. 29, 2012; and U.S. Provisional Application Ser. No. 61/911,310, entitled BOOST SYSTEM INCLUDING TURBO AND HYBRID DRIVE SUPERCHARGER, filed Dec. 3, 2013, which are hereby incorporated by reference in their entirety.

### TECHNICAL FIELD

The invention generally relates to a method of controlling an engine, and more specifically to a method of controlling an engine including a combustion air boosting system having a supercharger and a turbocharger disposed in-line relative to each other for boosting engine intake air pressure to increase the torque available from the engine.

### BACKGROUND

Internal combustion engines, particularly diesel engines, often include a boosting system to increase the pressure of the combustion air. The boosting system may include a turbocharger, which includes a compressor actuated by a turbine that is powered by a flow of exhaust gas from the engine. As is well known, the turbocharger lags behind the operation of the engine until the flow of exhaust gas through the turbine is sufficient to operate the compressor to pressurize the combustion air. Alternatively, the boosting system may include a supercharger, which is mechanically coupled to the engine, typically through a clutch. Because the supercharger is mechanically coupled to the engine, the supercharger is capable of operation almost immediately after the engine starts. However, the mechanical linkage between the supercharger and the engine draws power from the engine to operate the supercharger, thereby reducing the efficiency of the engine.

The boosting system may include both the turbocharger and the supercharger disposed sequentially in series. In such a boosting system, the supercharger is used when the turbocharger is operating inefficiently, such as during startup and initial acceleration. Once the turbocharger is operating efficiently, such as during high speed operation of the vehicle, the clutch disengages the supercharger from the engine to eliminate the power draw required to operate the supercharger. Because the turbocharger is powered by the flow of exhaust gas, operation of the turbocharger does not draw power from nor reduce the efficiency of the engine.

### SUMMARY

A method of controlling an engine is disclosed. The engine includes a combustion air boosting system for supplying a flow of pressurized combustion air to the engine. The boosting system includes a supercharger and a turbocharger. The supercharger is mechanically coupled to the engine. The turbocharger is disposed downstream from the supercharger. The boosting system further includes a combustion air bypass duct for bypassing a flow of air around the supercharger, and a combustion air bypass valve for controlling the flow of air through the combustion air bypass duct. The method includes maintaining operation of the turbocharger within an optimum operating range; manipulating the combustion air bypass valve to create a negative pressure differential across the supercharger between an inlet of the supercharger and an outlet of the supercharger to generate a rotational output of the supercharger; and transmitting the rotational output of the supercharger to the engine to increase an operating efficiency of the engine. In certain examples, torque is transmitted between the engine and the supercharger by a planetary gear set. In certain examples, the planetary gear set also interfaces with an electric motor/generator powered by a battery.

In another aspect of the invention, a method of controlling an engine is disclosed. The engine includes a combustion air boosting system for supplying a flow of pressurized combustion air to the engine. The boosting system includes a supercharger and a turbocharger. The supercharger is mechanically coupled to the engine. The turbocharger is disposed downstream from the supercharger. The boosting system further includes a combustion air bypass duct for bypassing a flow of air around the supercharger, and a combustion air bypass valve for controlling the flow of air through the combustion air bypass duct. The combustion air bypass valve includes an open position permitting unobstructed airflow through the combustion air bypass duct and a closed position preventing airflow through the combustion air bypass duct. The method includes maintaining operation of the turbocharger within an optimum operating range; manipulating the combustion air bypass valve to an intermediate position between the open position and the closed position to create a negative pressure differential across the supercharger between an inlet of the supercharger and an outlet of the supercharger to generate a torque; and transmitting the torque to the engine to increase an operating efficiency of the engine.

Accordingly, the method increases the operating efficiency of the engine by using the supercharger to convert excess combustion air pressure supplied by the turbocharger into torque, which is transmitted from the supercharger back to the engine. Additionally, the supercharger may be used on demand to provide the flow of combustion air to the engine during acceleration, before the turbocharger reaches an optimum operating efficiency, thereby providing near instantaneous pressurized combustion air on demand.

Another aspect of the disclosure includes a boost system that provides boost pressure to an air intake manifold of an engine having a crankshaft. The boost system includes a supercharger in series with a turbocharger. The supercharger has a first rotor mounted on and rotatable with a first shaft and a second rotor meshing with the first rotor and mounted on and rotatable with a second shaft via rotation of the first shaft. The supercharger and the turbocharger provide the boost pressure to the air intake manifold of the engine. An electric motor-generator is also provided. The electric motor-generator is selectively operable as a motor and as a generator and is coupled to a battery. An interface allows torque to be transferred (e.g., proportioned) between the crankshaft, the first shaft of the supercharger, and the electric motor-generator.

Another aspect of the disclosure includes a supercharger assembly for an engine having a crankshaft and an air intake manifold through which air flow is provided to the engine. The supercharger assembly includes a supercharger having a drive shaft and a clutch interconnecting the engine and the drive shaft of the supercharger. A hybrid drive system includes a planetary gear set allows torque to be transferred between the supercharger, and electric motor/generator, and the crankshaft of the engine. The planetary gear set is operable to transfer torque from the engine crankshaft to the supercharger under first operating conditions and to transfer torque from the supercharger to the engine crankshaft under second operating conditions.

A further aspect of the disclosure includes a method of controlling an engine having a combustion air boosting system supplying a flow of pressurized combustion air to the engine and includes a supercharger mechanically coupled to the engine. The method includes the steps of adjusting a position of a combustion air bypass valve to adjust a flow rate of the combustion air through the combustion air bypass duct to create a negative pressure differential across the supercharger between an inlet of the supercharger and an outlet of the supercharger to generate a rotational output of the supercharger. The rotational output of the supercharger can be transmitted to the engine using a planetary gear set between the supercharger and a crankshaft of the engine to transfer energy from the supercharger back toward the engine.

Further still an aspect of the disclosure includes a method of controlling an engine including a combustion air boosting system supplying a flow of pressurized combustion air to the engine and including a supercharger mechanically coupled to the engine. The boosting system includes a combustion air bypass duct for bypassing a flow of air around the supercharger and a combustion air bypass valve for controlling the flow of air through the combustion air bypass duct. The combustion air bypass valve has an open position permitting unobstructed airflow through the combustion air bypass duct and a closed position preventing airflow through the combustion air bypass duct. The method includes the steps of adjusting a position of the combustion air bypass valve to adjust a flow rate of the combustion air through the combustion air bypass duct to an intermediate position between the open position and the closed position to create a negative pressure differential across the supercharger between an inlet of the supercharger and an outlet of the supercharger to generate a torque. The torque is transmitted to a crankshaft of the engine through a mechanical connection between the supercharger and the crankshaft of the engine. The rotational output of the supercharger is defined as a torque applied from a drive shaft of the supercharger through the mechanical connection back to the crankshaft of the engine.

Another aspect of the present disclosure relates to a boost system for providing boost pressure to an air intake manifold of an engine. The boost system includes a turbocharger and a supercharger that cooperate to provide the pressure boost to the air intake manifold. The boost system also includes a hybrid drive system for powering the supercharger. In certain examples, the hybrid drive system includes a mechanical connection for transferring torque between the supercharger and the engine (e.g., between the engine crankshaft and a drive shaft of the supercharger) and a mechanical connection for transferring torque between a supplemental power source (e.g., an electric motor and/or an electric motor/generator) and the drive shaft of the supercharger. In certain examples, the hybrid drive can include a planetary gear set for transferring torque between the engine crankshaft and the drive shaft of the supercharger and between the supplemental power source and the drive shaft of the supercharger. In certain examples, a ring gear of the planetary gear set is coupled to the supplemental power source, a sun gear of the planetary gear set is coupled to the supercharger shaft and a carrier of the planetary gear set can be coupled to the engine crankshaft. Couplings can be made with gear sets, belts or other means. In certain examples, the hybrid drive has an arrangement (e.g., a planetary gear set) that allows torque to be transferred from the supercharger drive shaft to the engine (e.g., to the engine crankshaft) and for allowing torque to be transferred from the engine (e.g., from the engine crankshaft) to the supercharger drive shaft.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of an engine;

FIG. 2 is a flow chart showing a method of controlling the engine; and

FIG. 3 is a system layout showing an example combined turbocharger and supercharger boost system in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the inventive aspect disclosed herein.

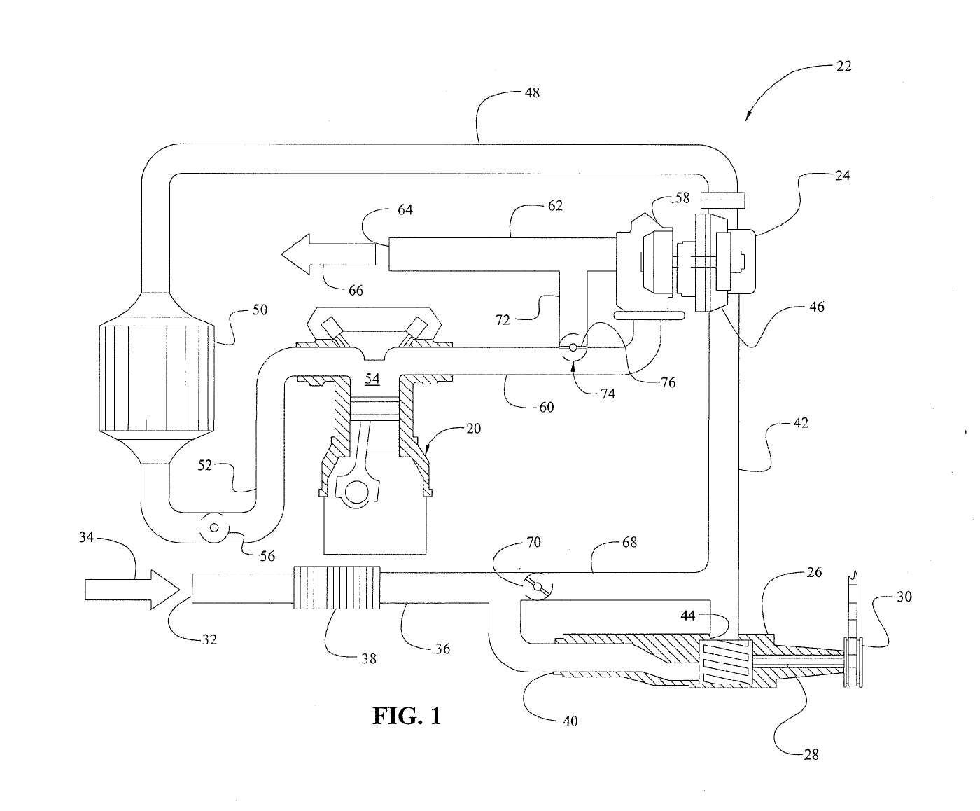

Referring to the Figures, wherein like numerals indicate corresponding parts throughout the several views, an internal combustion engine is shown generally at 20 in FIG. 1. In one example, the engine 20 includes a conventional engine, such as a diesel engine or a gasoline engine. As shown in FIG. 1, the engine 20 includes a “superturbo” boosting system 22, which includes both a turbocharger 24 and a supercharger 26 disposed sequentially in-line with each other to increase the boost, i.e., pressure, of combustion air of the engine 20. As is well known, a supercharger can have a first rotor (not shown) mounted on and rotatable with a first shaft (not shown) and a second rotor (not shown) meshing with the first rotor and mounted on and rotatable with a second shaft (not shown) via rotation of the first shaft.

The turbocharger 24 is powered by exhaust gas provided by the engine 20 as is well known. The supercharger 26 is mechanically linked to the engine 20, and is directly powered by the engine 20. The supercharger 26 includes a drive shaft 28 and a clutch 30 interconnecting the engine 20 and the drive shaft 28 of the supercharger 26. The clutch 30 is configured for selectively engaging and disengaging the supercharger 26. It should be understood by those skilled in the art that the clutch 30 may, within the scope of the present invention, comprise any type of clutch 30 (e.g., engageable friction discs, electromagnetic, etc.) that is effective in transmitting mechanical drive from the vehicle engine 20 (typically, but not necessarily, from the crankshaft) to the input shaft of the supercharger 26. Also, as is also now known to those skilled in the art, there may be some sort of “step-up gear” speed increasing arrangement between the clutch 30 and the input shaft, with a typical ratio for such a speed increasing arrangement being in the range of about 2:1 to about 4:1. An example supercharger is disclosed at U.S. Pat. No. 7,488,164, which is hereby incorporated by reference in its entirety.

The boosting system 22 includes a plurality of air ducts configured for communicating the combustion air to the engine 20. The air ducts communicate the combustion air to and from the engine 20. The air ducts include an intake 32, through which the combustion air enters the boosting system 22 in a direction indicated by arrow 34. A first air duct 36 includes a filter 38, and is in fluid communication with an inlet 40 of the supercharger 26. The combustion air enters the boosting system 22 through the intake 32, and flows through the filter 38 toward the supercharger 26.

A second air duct 42 connects an outlet 44 of the supercharger 26 with a pumping portion, i.e., a compressor 46, of the turbocharger 24. A third air duct 48 interconnects an outlet 44 of the compressor 46 with an inlet of an intercooler 50. The function of the intercooler 50 is known, and outside the scope of this invention. Accordingly, the function of the intercooler 50 is not described in detail herein. A fourth air duct 52 interconnects an outlet of the intercooler 50 with a combustion chamber 54 of the engine 20.

Disposed within the fourth air duct 52 is an engine throttle 56, illustrated herein in FIG. 1 in a fully open position. It should be appreciated that the engine throttle 56 may be controlled to be in any position between the fully open position shown in FIG. 1, and a fully closed position substantially blocking all air flow through the fourth air duct 52 and thereby limiting air flow into the combustion chamber 54 of the engine 20.

The turbocharger 24 also includes a turbine portion 58, which is mechanically coupled to and configured to drive the compressor 46. A fifth air duct 60 interconnects the combustion chamber 54 of the engine 20 with an inlet of the turbine portion 58 of the turbocharger 24 to provide the turbine portion 58 with the exhaust gas. A sixth air duct 62 interconnects an outlet 44 of the turbine portion 58 of the turbocharger 24 with exhaust exit 64. The exhaust gas flows out of the boosting system 22 through the exhaust exit 64 in a direction indicated by arrow 66.

Disposed between the first air duct 36 and the outlet 44 of the supercharger 26 is a combustion air bypass duct 68. Disposed within the combustion air bypass duct 68 is a combustion air bypass valve 70. The combustion air bypass valve 70 includes an open position permitting airflow through the combustion air bypass duct 68, and a closed position preventing airflow through the combustion air bypass duct 68. The combustion air bypass valve 70 is moveable into any intermediate position disposed between the open position and the closed position. Accordingly, the combustion air bypass valve 70 is continuously variable between the open position and the closed position.

An exhaust gas bypass duct 72 interconnects the fifth air duct 60 with the sixth air duct 62. A turbocharger controller 74 controls a flow of exhaust gas from the engine 20 through the exhaust gas bypass duct 72 and through the turbine portion 58 of the turbocharger 24. The turbocharger controller 74 may include, but is not limited to, an exhaust gas bypass valve, i.e., a wastegate 76, disposed within the exhaust gas bypass duct 72. The wastegate 76 may have a structure and function known in the turbocharger 24 art. Specifically, the wastegate 76 is moveable into any intermediate position between an open position and a closed position to adjust the flow of exhaust gas through the exhaust gas bypass duct 72 and through the turbine portion 58 of the turbocharger 24. The open position of the wastegate 76 permits exhaust gas to flow through the exhaust gas bypass duct 72, which decreases the flow of exhaust gas to the turbine portion 58 of the turbocharger 24, thereby reducing an operating speed of the turbocharger 24. The closed position of the wastegate 76 prevents the exhaust gas from flowing through the exhaust gas bypass duct 72, which increases the flow of exhaust gas to the turbine portion 58 of the turbocharger 24, thereby increasing the operating speed of the turbocharger 24. The operation of the turbocharger 24 is thereby controlled to stay within an optimum operating range.

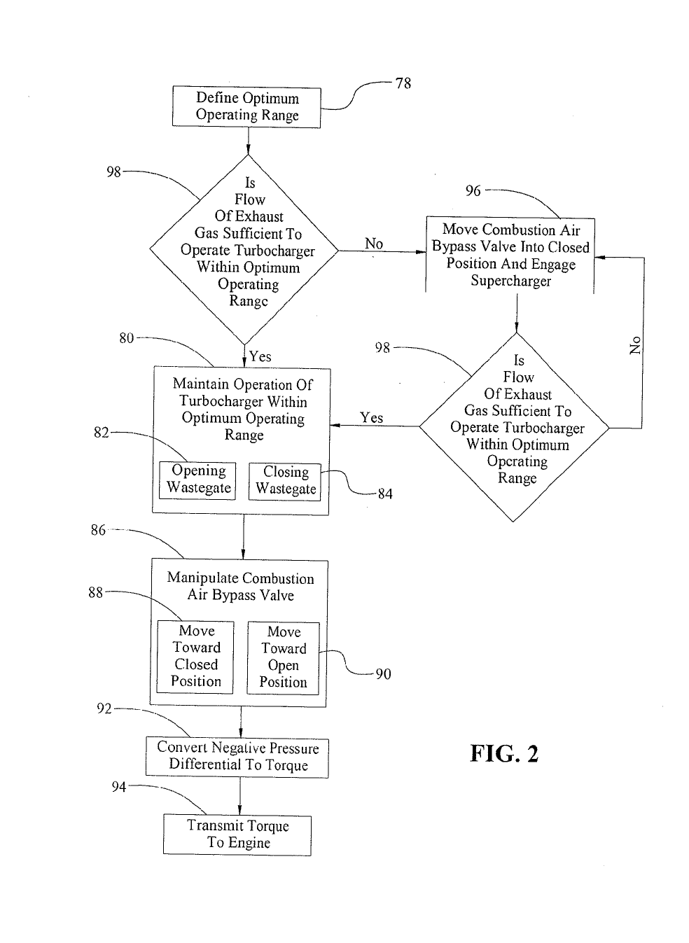

Referring to FIG. 2, a method of controlling the engine 20 described above is also disclosed. The method includes defining an optimum operating range of the turbocharger 24 (block 78). The optimum operating range of the turbocharger 24 is specific to the particular type, size and manufacturer of turbocharger 24, as well as to the particular type, size and manufacture of the engine 20. As such, it should be appreciated that the optimum operating range varies with each application. The optimum operating range of the turbocharger 24 is the operational range within which the turbocharger 24 operates most efficiently.

The optimum operating range of the turbocharger 24 may be defined by any suitable parameter used to measure the performance of the turbocharger 24. Accordingly, the optimum operating range of the turbocharger 24 may include a range defined by the operating speed of the turbocharger 24, the operating boost provided by the turbocharger 24, or some other parameter suitable for quantifying the operation of the turbocharger 24. As such, defining the optimum operating range of the turbocharger 24 may further include defining an optimum operating speed range in which the turbocharger 24 operates most efficiently.

The method further includes maintaining operation of the turbocharger 24 within the optimum operating range (block 80). The operation of the turbocharger 24 depends upon and fluctuates with the flow of exhaust gas from the engine 20. As described above, the turbocharger controller 74 is configured for controlling a flow of exhaust gas through the turbine portion 58 of the turbocharger 24. Accordingly, the turbocharger controller 74 operates to maintain the operation of the turbocharger 24 within the optimum operating range. As such, the method further includes manipulating the turbocharger controller 74 to control an exhaust gas flow rate through the turbine portion 58 of the turbocharger 24 to maintain operation of the turbocharger 24 within the defined optimum operating range.

If the turbocharger controller 74 includes the exhaust gas bypass duct 72 for bypassing the exhaust gas around the turbocharger 24, and the wastegate 76 disposed within the exhaust gas bypass duct 72 for controlling a flow of exhaust gas through the exhaust gas bypass duct 72 as described above, then manipulating the turbocharger controller 74 may further include manipulating the wastegate 76 to regulate the flow rate of the exhaust gas through the exhaust gas bypass duct 72. Manipulating the wastegate 76 may include one of opening the wastegate 76 to increase the flow of exhaust gas through the exhaust gas bypass duct 72 to decrease the operating speed of the turbocharger 24 (block 82), and closing the wastegate 76 to decrease the flow of exhaust gas through the exhaust gas bypass duct 72 and increase the operating speed of the turbocharger 24 (block 84).

The method further includes manipulating the combustion air bypass valve 70 to create a negative pressure differential across the supercharger 26 between an inlet 40 of the supercharger 26 and an outlet 44 of the supercharger 26 (block 86). Manipulating the combustion air bypass valve 70 may further include changing a position of the combustion air bypass valve 70 to adjust a flow rate of the combustion air through the combustion air bypass duct 68. Changing the position of the combustion air bypass valve 70 may further include moving the combustion air bypass valve 70 toward the closed position to further restrict airflow through the combustion air bypass duct 68 and decrease the negative pressure differential across the supercharger 26 (block 88). Alternatively, changing the position of the combustion air bypass valve 70 may further include moving the combustion air bypass valve 70 toward the open position to increase airflow through the combustion air bypass duct 68 and increase the negative pressure differential across the supercharger 26 (block 90).

Because operation of the turbocharger 24 is maintained within its optimum operating range, the turbocharger 24 continuously draws a flow of combustion air through the first air duct 36 and the second air duct 42 across the inlet 40 and the outlet 44 of the supercharger 26. The continuous flow of combustion air across the inlet 40 and the outlet 44 of the supercharger 26 is sufficient to create the negative pressure differential therebetween, i.e., a vacuum between the inlet 40 and the outlet 44 of the supercharger 26. Manipulation of the combustion air bypass valve 70 adjusts, i.e., increases or decreases, the negative pressure differential between the inlet 40 and the outlet 44 of the supercharger 26.

The method further includes converting the negative pressure differential across the supercharger 26 into a rotational output of the supercharger 26 (block 92). Accordingly, manipulating the combustion air bypass valve 70 generates the rotational output of the supercharger 26. Converting the negative pressure differential across the supercharger 26 into a rotational output of the supercharger 26 may further be defined as converting the negative pressure differential across the supercharger 26 into a torque applied to the drive shaft 28. It should be appreciated that the negative pressure differential between the inlet 40 and the outlet 44 of the supercharger 26, i.e., the vacuum created across the supercharger 26, spins the drive shaft 28 and thereby imparts a torque into the drive shaft. As such, the combustion air drawn through the first air duct 36 and the second air duct 42 by the turbocharger 24 produces the torque in the drive shaft. Maintaining the operation of the turbocharger 24 within the optimum operating range of the turbocharger 24 ensures that the flow of combustion air across the supercharger 26 is sufficient to create the negative pressure differential and spin the supercharger 26.

The method further includes transmitting the rotational output of the supercharger 26, i.e., the torque applied to the drive shaft 28 of the supercharger 26, to the engine 20 to increase an operating efficiency of the engine 20, indicated at 94. Accordingly, the torque is transmitted from the drive shaft of the supercharger 26 to the engine 20 through the clutch 30. The torque from the supercharger 26 is preferably transferred to the crankshaft of the engine 20 and supplements the torque produced by the engine 20. In this manner, the torque applied to the drive shaft 28 of the supercharger 26 is transferred to the engine 20 to increase the power and/or efficiency of the engine 20. In certain examples, a planetary gear set can provide a mechanical interface or torque transfer arrangement for allowing torque to be transferred from the supercharger to the engine crankshaft during first operating conditions (e.g., when negative pressure across the supercharger is converted to torque) and for allowing torque to be transferred from the engine crankshaft to the supercharger under second operating conditions (e.g., when supplemental boost is needed from the supercharger).

The method may further include moving the combustion air bypass valve 70 into the closed position (block 96) to create a positive pressure differential across the supercharger 26 between the inlet 40 of the supercharger 26 and the outlet 44 of the supercharger 26, such that the supercharger 26 supplies the pressurized combustion air to the engine 20 on demand. The supercharger 26 may be required to supply the boost to the combustion air during certain operating conditions, such as initial engine run-up, before the flow of exhaust gas is sufficient to operate the turbocharger 24 within the optimum operating range of the turbocharger 24 (block 98). Once the turbocharger 24 is operating within the optimum operating range, then the combustion air bypass valve 70 is manipulated as described above.

In prior art systems, the combustion air bypass valve 70 would be moved into the fully open position to permit unobstructed air flow through the first air duct 36 and the second air duct 42 when the turbocharger 24 is operational to supply the boost to the combustion air. However, as disclosed herein, when the turbocharger 24 is operating within the optimum operating range, the combustion air bypass valve 70 is manipulated to create the negative pressure differential across the supercharger 26, which generates a torque in the drive shaft 28 of the supercharger 26. Accordingly, as disclosed herein, the combustion air bypass valve 70 is normally disposed in an intermediate position, somewhere between the fully open position and the fully closed position of the combustion air bypass valve 70 when the turbocharger 24 is operational to supply the boost to the combustion air. The torque generated by the negative pressure differential across the supercharger 26 is essentially free energy that is then transferred back into the engine 20 to improve the efficiency of the engine 20.

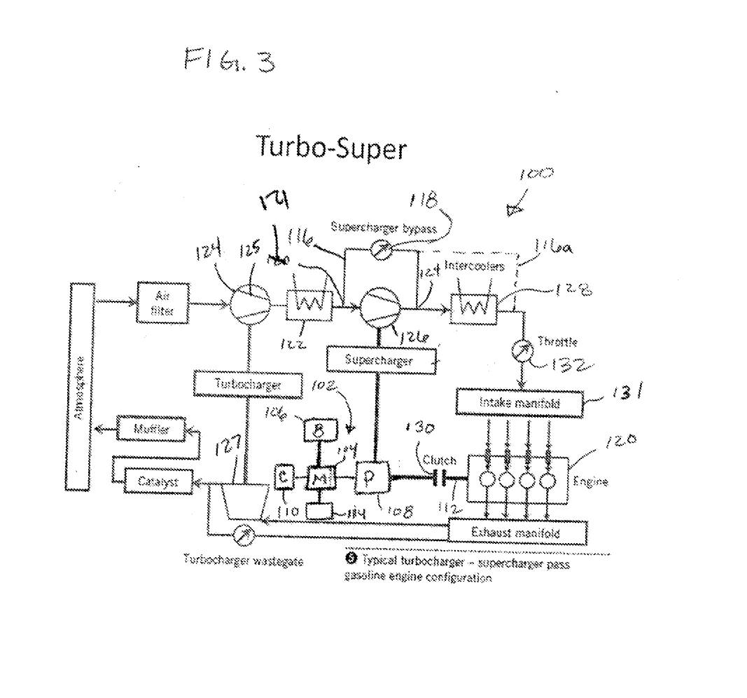

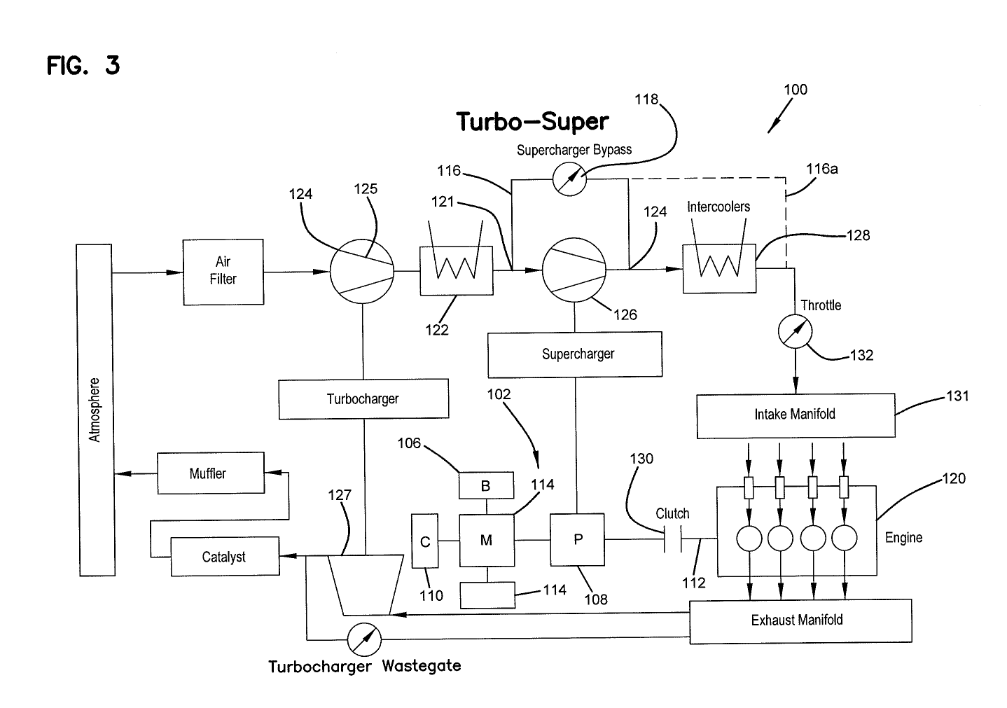

FIG. 3 illustrates another example of an example boosting system 100 in accordance with the principles of the present disclosure for boosting the intake air pressure provided to an engine 120. In certain examples, the engine 120 can include a gasoline engine having an intake manifold 131 and a throttle 132. The boosting system 100 is depicted including a supercharger 126 and a turbocharger 124. The supercharger 126 and the turbocharger 124 are positioned along an air intake of the engine 120 with the supercharger 126 being positioned downstream from the turbocharger 124. The turbocharger 124 includes at least one rotor 125 for boosting air pressure at the engine intake and a turbine 127 exposed to engine exhaust for extracting energy from the engine exhaust to power the rotor 125.

In one example, the boosting system 100 includes the supercharger 126 powered by a hybrid drive system 102. The hybrid drive system 102 can be configured to use torque mechanically transferred from the engine 120 (e.g., from the engine crankshaft) to drive the supercharger 126, and is also configured to use torque generated from an electric motor/generator 104 to provide torque to the supercharger 126. The electric motor/generator 104 can be powered by a battery 106 when functioning as an electric motor, and can be used to charge the battery 106 when functioning as a generator 104. In certain examples, the electric motor/generator 104 can include an internal stop mechanism or a brake for braking the electric motor/generator 104 when it is desired to stop rotation of the output/input shaft of the electric motor/generator.

In certain examples, the electric motor/generator 104 can interface with an electronic controller that controls operation of the brake and also controls operation of the electric motor/generator 104 in both the generating state and in the motoring state. The hybrid drive system 102 can further include a gear set such as a planetary gear set 108 that allows torque to be transferred between the supercharger 126, the electric motor/generator 104 and the crankshaft of the engine 120. The planetary gear set 108 can be a simple planetary gear set. In other examples, a compound planetary gear set can be used.

In some examples, the electric motor/generator 104 can transfer torque to or receive torque from the planetary gear set 108 through a gear train. The system can be controlled to capture energy during vehicle braking in a regenerative braking mode. For example, when vehicle braking slows the drive axle, a controller 110 can be configured to brake rotation of the supercharger rotors and control the electric motor/generator 104 to function as a generator with torque applied to the electric motor/generator 104 in a reverse direction that is the opposite of the direction of torque supplied by the electric motor/generator 104 when the electric motor/generator 104 functions as a motor. Reverse torque can thus be applied to the engine crankshaft through the planetary gear set 108. In certain examples, a clutch 130 can be provided for selectively coupling the planetary gear set 108 to the engine 120 and for decoupling the planetary gear set 108 from the engine 120.

In certain examples, the hybrid drive system 102 can be configured to provide various functions and can be operated in various modes. In certain examples, the hybrid drive system 102 can be provided with a brake for applying a braking force to the rotors of the supercharger 126 such that the rotors of the supercharger 126 are prevented from rotating. In such an example, with the supercharger brake open, the electric motor/generator 104 can be operated to vary the speed of the supercharger 126 to control and vary the boost rate based on the operating condition of the engine. This mode can be referred to as a variable speed boost mode. In this mode, torque from the electric motor/generator 104 can be used to boost the speed of the supercharger to a rate that is higher than can be achieved mechanically via torque from the engine crankshaft alone. In this mode, the electric motor/generator 104 can also be operated as a generator and used to slow the speed of the supercharger 126 to a speed slower than what would be provided mechanically via the gear ratio between the engine crankshaft and the supercharger input shaft. In this case, excess charge air is reduced and the battery can be recharged.

In an engine start/stop mode, the supercharger brake can be locked and the electric motor 104 can provide torque to the engine for starting. With the supercharger brake locked, the system can be operated in a brake regeneration mode in which the electric motor/generator 104 is operated as a generator and is used to recover energy associated with braking (i.e., torque from the crankshaft is transferred to the motor/generator thereby slowing the engine during braking) With the supercharger brake locked, the boosting system can be operated in a torque assist mode in which the electric motor 104 is operated as a motor and is used to provide supplemental torque to the engine. With the supercharger brake locked, the hybrid drive system 102 can also be operated in an alternator mode in which the electric motor/generator functions as a generator and uses torque from the engine to charge the battery. It will be appreciated that further details relating to example hybrid drive systems that can be incorporated into the present boosting system are disclosed in U.S. Provisional Patent Application Ser. No. 61/911,310; and PCT Application No. PCT/US2013/003094, both of which are hereby incorporated by reference in their entireties.

If vehicle operating conditions indicate that the engine 120 should be started, the engine assembly can be transitioned from the engine-off operating mode to an engine-start operating mode simply by engaging the clutch 130 while still controlling the electric motor/generator 104 to function as a motor and keeping the supercharger brake engaged. Torque from the electric motor/generator 104 will thus be applied to a crankshaft 112 to start the engine 120. Once the engine 120 is started, the electric motor/generator 104 can freewheel, with the controller 110 neither directing electric energy from an energy storage device 114 to the electric motor/generator 104, nor directing electric energy from the electric motor/generator 104 to the energy storage device 114. The start/stop ability of the electric motor/generator 104 allows the engine 120 to be shut off rather than idle, such as at traffic lights, with an expected increase in fuel economy and reduction in carbon dioxide emissions. Thus, fuel savings can be realized during the period that the engine 120 is shutoff, and restarting the engine 120 can be accomplished with the electric energy generated from recaptured energy stored in the battery 106.

Alternatively, once the engine 120 is started, the electric motor/generator 104 can function either as a motor or as a generator. With the engine 120 on, engine boost, brake regeneration and throttle loss regeneration modes may be used. An engine boost operating mode can be established by the controller 110 when additional torque is required at the drive axle, such as for vehicle acceleration. To establish the boost operating mode with the engine 120 on, the clutch 130 is engaged and the supercharger brake is disengaged. The electric motor/generator 104 is controlled to function as a motor and set the desired rotational speed of rotor shafts of the supercharger, providing desired boost pressure. Because the boost pressure provided in the plenum by the supercharger 126 is independent of engine speed, a relatively constant torque can be obtained at the crankshaft 112 across the entire range of operating speeds of the engine 120. Alternately, the torque at the crankshaft 112 can be tailored as desired across the range of engine operating speeds.

The boosting system 100 can include a bypass line 116 that bypasses the supercharger 126. Flow through the bypass line 116 is controlled by a valve 118 that can open flow, close flow or proportion flow. As depicted, the bypass line 116 has an upstream end 121 positioned between an intercooler 122 and the supercharger 126 and a downstream end 124 positioned between the supercharger 126 and the intercooler 128. In an alternative embodiment, the downstream end of the bypass line 116 can be positioned downstream of the intercooler 128 as shown by dash line 116a. In such an example, the bypass line 116 would bypass the supercharger 126 and the intercooler 128.

In the depicted embodiment, a throttle 132 is positioned between the supercharger 126 and the engine 120 such that the throttle 132 is positioned downstream from the supercharger 126. In other examples, the throttle 132 can be positioned upstream from the supercharger 126.

When the engine 120 is on and engine boost is not required, such as during vehicle cruising at a relatively steady vehicle speed, the controller can slow the speed of the supercharger 126 and control the throttle 132 so that the throttling losses (i.e., the pressure drop associated with the vacuum created by the moving engine cylinders) can be applied across both the throttle 132 and the supercharger 126 with the bypass valve 118 closed. The position of the throttle 132 can be balanced with the pressure drop desired across the supercharger 126 and air flows through both the supercharger 126 and past the at least partially closed throttle 132 to reach the engine cylinders. The bypass valve 118 can also be controlled during this mode to allow air to bypass the supercharger 126 when a rapid change in air flow to the engine 120 is required. The pressure drop across the supercharger drives rotation of the supercharger rotors thereby generating output torque at the supercharger drive shaft. The torque generated by the pressure drop across the supercharger 126 will be applied to the planetary gear set 108, and thus to the engine crankshaft and also to the motor-generator 104 (when controlled to operate as a generator) via the torque split provided by the planetary gear set 108. This operating mode can be referred to as a throttling loss regeneration mode. All or a portion of the torque generated by the pressure drop across the supercharger 126 can be converted to electric energy stored in the energy storage device 106 by controlling the motor-generator 104 to function as a generator. The stored electric energy generated from the pressure drop-induced torque is referred to as being from “recaptured throttling losses.” In certain conditions, all of the torque generated at the supercharger by pressure drop across the supercharger 126 can be transferred back to the engine crankshaft through the planetary gear set. In certain conditions, all of the torque generated at the supercharger by pressure drop across the supercharger 126 can be transferred back to the motor/generator 104 through the planetary gear set for conversion to energy stored at the energy storage device 106 (e.g., a battery). In certain examples, torque generated at the supercharger by pressure drop across the supercharger 126 can be transferred back to both the engine crankshaft and the motor/generator 104.

During an extended cruising period, when engine boost is not required, the throttling loss regeneration mode can be maintained until the energy storage device 64 reaches a predetermined maximum state of charge. Then, the brake 68 can be applied, the bypass valve 70 opened to position 70A, and the motor-generator 50 controlled to function as a motor to apply torque to the engine crankshaft 48 until the energy storage device 64 reaches a predetermined minimum state of charge. This cycling of charging and depleting the energy storage device 64 can continue throughout the cruising period.

In one example, the pressure drop across the supercharger 12 is increased an amount delta. This delta, which results in a larger pressure drop across the supercharger 12 for all engine speeds, assures that the pressure drop does not diminish to the point that the pressure differential is essentially zero. In one example, the delta is applied at least at low engine speeds. In another example, the delta is applied at all engine speeds. In this manner, continuous energy can be captured through throttle loss regeneration, with only a marginal impact on fuel economy.

In such an example, the control system is configured to control the electric motor-generator to function as the generator and the throttle valve is controlled to move to a relatively open position so that the pressure drop across the supercharger is equal to or greater than the original throttle pressure drop such that the electric motor-generator, through the planetary gearing arrangement, captures the throttling as electric energy.

In the depicted example of FIG. 3, the supercharger 126 is downstream from the turbocharger 124. In other examples, the supercharger 126 can be positioned upstream from the turbocharger 124.

An example method of controlling the engine 20 described above is provided in accordance with the principles of the present disclosure. The method includes converting the negative pressure differential across the supercharger 26 into a rotational output of the supercharger 26. Converting the negative pressure differential across the supercharger 26 into a rotational output of the supercharger 26 may further be defined as converting the negative pressure differential across the supercharger 26 into a torque applied to the drive shaft 28. It should be appreciated that the negative pressure differential between the inlet and the outlet of the supercharger 26, spins the drive shaft 28 and thereby imparts a torque into the drive shaft 28.

The method further includes transmitting the rotational output of the supercharger 26, i.e., the torque applied to the drive shaft 28 of the supercharger 26, to the engine 20 to increase an operating efficiency of the engine 20. Accordingly, the torque is transmitted from the drive shaft 28 of the supercharger 26 to the engine 20 through the clutch 30 using the planetary gear set 108. The torque from the supercharger 26 is preferably transferred to the crankshaft of the engine 20 and supplements the torque produced by the engine 20. In this manner, the torque applied to the drive shaft 28 of the supercharger 26 is transferred to the engine 20 to increase the power and/or efficiency of the engine 20.

From the forgoing detailed description, it will be evident that modifications and variations can be made without departing from the spirit and scope of the disclosure.

What is claimed is:

1. A method of controlling an engine including a combustion air boosting system supplying a flow of pressurized combustion air to the engine and including a supercharger mechanically coupled to the engine, the boosting system including a combustion air bypass duct for bypassing a flow of air around the supercharger and a combustion air bypass valve for controlling the flow of air through the combustion air bypass duct, the method comprising:
adjusting a position of the combustion air bypass valve to adjust a flow rate of the combustion air through the combustion air bypass duct to create a negative pressure differential across the supercharger between an inlet of the supercharger and an outlet of the supercharger to generate a torque converting a negative pressure differential across the supercharger into a torque applied to a drive shaft of the supercharger, wherein the negative pressure differential between the inlet and the outlet of the supercharger, spins the drive shaft and thereby imparts a torque to the drive shaft; and
outputting the torque as a rotational output from the supercharger drive shaft to a crankshaft of the engine through a mechanical connection between the supercharger and the crankshaft of the engine, wherein the rotational output of the supercharger is defined as a torque applied from a drive shaft of the supercharger through the mechanical connection back to the crankshaft of the engine.

2. The method of claim 1, wherein the bypass valve is movable between open and closed positions.

3. The method of claim 1, wherein the bypass valve is positioned at an intermediate position between the open and closed positions when adjusting the flow rate of the combustion air through the bypass duct.

4. The method of claim 1, wherein the mechanical connection is a planetary gear set.

5. The method of claim 4, wherein the planetary gear set is also coupled to an electric motor/generator such that torque can be transferred between the supercharger and the electric motor/generator and between the supercharger and the crankshaft of the engine.

6. A method of controlling an engine including a combustion air boosting system supplying a flow of pressurized combustion air to the engine and including a supercharger mechanically coupled to the engine, the method comprising:
converting a negative pressure differential across the supercharger into a torque applied to a drive shaft of the supercharger, wherein the negative pressure differential between an inlet and an outlet of the supercharger, spins the drive shaft and thereby imparts a torque into the drive shaft; and
transmitting the torque applied to the drive shaft of the supercharger to the engine using an interface between the supercharger and a crankshaft of the engine.

7. The method of claim 6, wherein the interface is a planetary gear set.

8. The method of claim 7, wherein the planetary gear set is also coupled to an electric motor/generator such that torque can be transferred between the supercharger and the electric motor/generator and between the supercharger and the crankshaft of the engine.

9. A boost system for providing boost pressure to an air intake manifold of an engine, the boost system comprising:
a turbocharger and a supercharger that cooperate to provide the pressure boost to the air intake manifold; and
a hybrid drive system for powering the supercharger, wherein the hybrid drive system includes a torque transfer arrangement that transfers torque between the engine and the supercharger and that transfers torque between the supercharger and a supplemental power source.

10. The boost system of claim 9, wherein the supplemental power source includes a motor/generator.

11. The boost system of claim 10, wherein the motor/generator is an electric motor/generator coupled to a battery.

12. The boost system of claim 10, further comprising a bypass line that bypasses the supercharger.

13. The boost system of claim 9, wherein the hybrid drive system includes an electric motor/generator coupled to a battery, and wherein the hybrid drive system also includes a planetary gear set that provides a torque transfer interface between the engine, the electric motor and the supercharger.

14. The boost system of claim 13, wherein a clutch is provided between the planetary gear set and the engine for selectively engaging and disengaging the planetary gear set form the engine.
